(19) United States
(12) Patent Application Publication
(10) Pub. No.: US 2025/0225539 A1
(43) Pub. Date: Jul. 10, 2025

(54) TREND IDENTIFICATION SYSTEMS AND METHODS

(71) Applicant: Kairos Research LLC, Dayton, OH (US)

(72) Inventors: Jeffrey Cail, Dayton, OH (US); Joshua L. Fiechter, Dayton, OH (US); Brandon S. Minnery, Dayton, OH (US); Srikanth Nadella, Dayton, OH (US); Benjamin Locke Welborn, Dayton, OH (US)

(21) Appl. No.: 19/008,177

(22) Filed: Jan. 2, 2025

Related U.S. Application Data
(60) Provisional application No. 63/617,511, filed on Jan. 4, 2024.

(51) Int. Cl. G06Q 30/0202; G06F 16/21; G06F 16/215

(52) U.S. Cl. CPC G06Q 30/0202; G06F 16/211; G06F 16/215

(57) ABSTRACT

Systems and methods are disclosed for market research and social media categorization solutions and methods that are capable of using data from existing social networks, news or reference resources, and other information systems to automate the process of grouping data items into labeled categories by topic. These embodiments can extract greater market insight from available data sources, provide greater predictive value to marketing or sales strategies, and save money by being more efficient or easier to implement into existing systems

### CROSS REFERENCE TO RELATED INFORMATION

This application claims the benefit of United States of America priority application No. 63/617,511 filed on Jan. 4, 2024, titled “Trend Identification Systems and Methods,” the contents of which are hereby incorporated herein in its entirety.

### TECHNICAL FIELD

The present disclosure generally relates to market and consumer prediction systems.

### BACKGROUND

Market research is a difficult but essential task that can yield great value if results are accurate or predictive of consumer behavior. Sources for market research can include sale information, industry news sources, social media postings, consumer survey results and other data. Social networks such as X/Twitter, Facebook, TikTok, provide a potentially unlimited data source regarding consumer opinion and behavior. However, analyzing data from social networks is challenging due to the large number of data points and the difficulty in automating a tool capable of organizing, categorizing, interpreting, and summarizing the data in a manner useful for market researchers.

### BRIEF DESCRIPTION OF THE DRAWINGS

For a more complete understanding of the present disclosure, reference is now made to the following descriptions taken in conjunction with the accompanying drawings, in which:

FIG. 1 illustrates one embodiment of a market research system under the present disclosure;

FIG. 2 shows a flow chart of a method embodiment under the present disclosure;

FIG. 3 shows an embodiment of a computing device for use in various embodiments under the present disclosure;

FIG. 4 shows an example flow chart of training and inference pipelines for machine learning in accord with some embodiments under the present disclosure;

FIG. 5 shows an embodiment of a neural network under the present disclosure;

FIG. 6 shows an example temporal analysis and trend extraction under the present disclosure; and

FIG. 7 shows an example model of topic trend data under the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There currently exist certain challenges in the realm of extracting market research insights from social media posts and related data sources such as news articles and online product reviews. The potential data pool contains billions of posts, but each “data point” is from a unique user, with unique grammar, language and modes of expression. Keyword searching provides some value but is unable to extract meaning beyond the mere presence of a word or group of words.

Certain aspects of the embodiments disclosed herein provide solutions to these or other challenges. Embodiments include market research and social media categorization solutions and methods that are capable of using data from existing social networks, news or reference resources, and other information systems to automate the process of grouping data items into labeled categories by topic. These embodiments can extract greater market insight from available data sources, provide greater predictive value to marketing or sales strategies, and save money by being more efficient or easier to implement into existing systems.

Certain embodiments may provide one or more of the following technical advantages. Certain embodiments provide automated categorization of news and social media data, increased predictive market information, and increased ability to measure results of company/sales tactics.

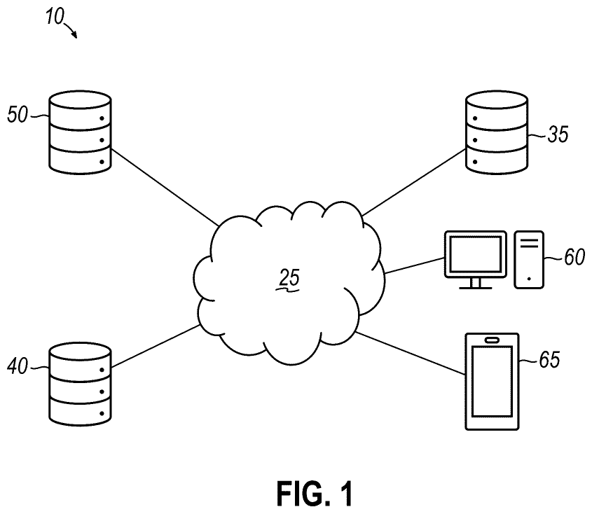

FIG. 1 displays a possible market research system 10 under the present disclosure. User devices 60, 65 (e.g., computer 60 and mobile device 65) can comprise a variety of user computing device(s) for accessing system 10. User devices 60, 65 could comprise smartphones, tablets, computers, servers, other computing devices, and combinations of any of the foregoing. User devices 60, 65 can display user interfaces for accessing, manipulating, and carrying out various market research analyses and processes as described further herein. Social network(s) 50 can comprise a social network such as Twitter™/X™, Facebook™, TikTok™, etc. Social network(s) 50 can comprise an accessible compilation of all or a portion of the data/posts related to the respective social network 50. Social network(s) can comprise a variety of computing devices, e.g., servers, computers, databases, smartphones, tablets, other computing devices, and/or combinations of any of the foregoing. Data source(s) 40 can comprise any of a variety of data sources, e.g., libraries, newspapers, YouTube™, Reddit™, encyclopedias, or a variety of other information sources. Data source(s) 40 can comprise an accessible compilation of all or a portion of the data related to, or offered by, a respective data source 40. Data source(s) can comprise a variety of computing devices, e.g., servers, databases, computers, smartphones, tablets, other computing devices, and/or combinations of any of the foregoing. It should be noted that a social network 50 could be considered a type of data source, and vice versa, without limiting the teachings described herein. Research server(s) 35 can comprise a market research server utilized by users of system 10 to compile, analyze, monitor and otherwise manipulate or utilize market research data, such as data received or pulled from social networks 50 and/or data sources 40. Research server(s) 35 can comprise a variety of computing devices, e.g., servers, computers, databases, smartphones, tablets, other computing devices, and/or combinations of any of the foregoing. Research servers 35 can comprise storage of accumulated data. Network(s) 25 can comprise a communication network that provides communicative coupling between the elements of system 10. Network 25 can comprise one or more communication networks, e.g., the internet, enterprise networks, Wi-Fi, cellular, 5G, satellite, hardline networks, local area networks, WiMax, other networks, and/or combinations of the foregoing. Components of system 10 may be configured to interface over a variety of protocols, e.g., application programming interfaces, hypertext markup language (HTML), Python, and/or others.

As noted above, one potentially valuable source of information for market research and analysis is social media posts. Online sources where users provide comments, like Reddit, newspapers, ecommerce site reviews, or YouTube, can similarly provide a valuable resource. But such data sources have to be collected and curated into a usable format to facilitate storage, organization, review, and analysis. Keyword searching could be a first step. But further processing is necessary to glean deep insights. For example, the following social media posts might all be useful for market analysis to a company such as Nike™. But each post conveys a different type of meaning and may need to be analyzed or grouped with other messages in different ways to reveal significant trends.
“Nike Builds New Store in NYC.”
“Nike Grew by 5% in the 4^{th} Quarter of 2023.”
“Nike Loses Share of Soccer Market”
“Nike Settles Patent Lawsuit”

Performing a keyword search is a one possible first step to identifying potentially informative posts; however, the mere presence of a keyword in a post does not guarantee its relevance. Instead, additional analysis may be helpful in order to group together similar posts into meaningful trends and to summarize these trends in a manner that renders them understandable to market researchers.

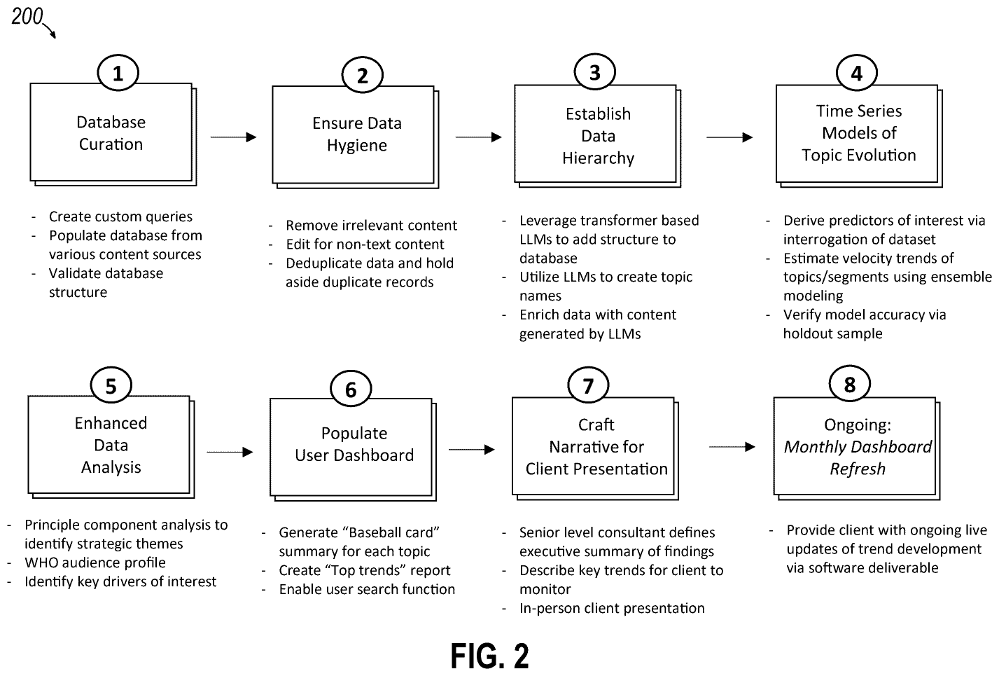

FIG. 2 displays a possible method embodiment 200 under the present disclosure. Method 200 may be performed by one or more of, e.g., research server(s) 35 of FIG. 1, user devices 60, 65 of FIG. 1, or other components of system 10. Method 200 may be carried out amongst multiple components of FIG. 1, with the process managed by e.g., research server(s) 35, or user device(s) 60, 65.

Step 1 can be database curation. Step 1 can comprise e.g., creating custom queries to run across one or more data sources, e.g., Twitter™/X™, Facebook™, and then populating a database with the queried data from the one or more data sources. Creating custom queries can be done to spread a big umbrella over a topic, e.g., electric vehicles. Custom queries can be run across selected data sources to pull in a large database of posts, articles, news items, etc. related to a topic such as electric vehicles. Step 1 can also involve a validation of database structure. This may involve ensuring that the collected data shares a certain format(s) that will lead to easier manipulation in later steps of the process. Some embodiments of step 1 may involve using a resource such as Netbase Quid™, Synthesio™, and Brandwatch™, all of which offer significant access to social media data. Some embodiments may involve using an API to access Twitter™/X™, or other sources which avoid aggregators such as Brandwatch.

Step 2 can be ensuring data hygiene. This can involve removing irrelevant context from social media posts; editing for non-text content; and deduplicating data and holding aside duplicate records. Irrelevant context might involve time or location data in some instances (although for some topics, time or location might be relevant). Non-text content could comprise photos, audio, or other content. This data might be susceptible to e.g., speech to text software to make e.g., video or audio text searchable. Photos may be able to be processed to extract valuable data, e.g., brand names, or other text. Some embodiments of step 2 can involve taking raw text and passing it through preprocessing steps that e.g., splits it up into words and normalizes aspects such as the punctuation and case. After that, the preprocessing can contextualize the data with embedding models that may turn posts/articles/etc. into a word or a sentence vector that represents the semantic meaning of the corresponding text. Offensive or inappropriate text can be pruned from text data in this process. Translation between languages may also be involved.

Step 3 can be establishing data hierarchy. This can include leveraging transformer based LLMs (large language models) to add structure to the database, utilizing LLMs to organize the data into topics, trends, and themes, and enriching data with content generated by LLMS (for example, adding labels and ratings to the identified topics, trends, and themes). For example, LLMs can be used to select and/or put all the data into database structures that may be most amenable to analysis. In some embodiments, the LLMs may group all the data into topic or labelled groups, utilizing topic modelling or other clustering techniques in order to assign textual data to one or more (possibly hierarchical) categories or classes. For example, if an overarching or broader topic is electric vehicles, the collected data may fall into groups such as: range anxiety, Tesla, Ford, charger location, Chevrolet, charger types, and others. One embodiment of a LLM that may be used in step 3 is BERTopic. BERTopic, and some other embodiments, exploit contextualized word or sentence embeddings to encode texts or text elements into a dense space as a precursor to clustering. Other embodiments could use other AI/ML models, Bayesian approaches, Latent Dirichlet Allocation (LDA) approaches, and other LLMs or AI/ML are possible. Outputs of e.g., a LLM like BERTopic may need to be further refined-so multiple steps of labels/topics may be utilized. In order to establish a data hierarchy, topics that exceed a certain proportion of the database are iteratively partitioned by fitting a subsidiary model on the content of only the data elements associated with those enlarged topics. Derivative sub-topics (i.e., those identified by the subsidiary model on the dataset partition in question) are compared to the topics identified in the main model and either A) merged with main model topics to which they exhibit high similarity, B) added to the main model as new topics, or C) discarded from the model as irrelevant. This process of decomposing and reintegrating topics and themes enables the formation of more robust, actionable, and generalizable topics and themes. The initial embedding vector space may be used to compute metrics or relevant topic similarity and cohesion, or an additional LLM may be queried to determine candidate topic relatedness. Sometimes, numerous iterations of decomposition and recombination may be required. Thus, Step 3 can involve e.g., taking the output of an initial topic model (e.g., BERTopic) and making it more usable in a stepwise procedure. In addition to decomposing larger topics, small topics (with only a few data points) may be combined to form a bigger group, merged to existing topics to which they are similar, or may be discarded from the model. Small topic integration and aggregation may also depend upon relations between topics in the vector embedding space, or inference regarding topic relatedness using another LLM. Commonly, output from BERTopic can be thousands of groupings. But there are commonly several very big topics (with hundreds or thousands of data points) and hundreds of small topics (with only a few data points). Embodiments under the present disclosure can leverage the newest generative AI tools to assist in organizing these topics in order to create usable, generalizable insights. In addition, the newest generative AI tools can provide enhanced characteristics to many topics at scale by using carefully designed, custom queries. These queries add a series of quantitative ratings to the database. This stepwise procedure (iterative refinement of data hierarchy followed by generative AI-based characterization of topic/trend characteristics) allows for a much deeper profiling of topics than might be otherwise available. In one embodiment this step can involve using AI (e.g., generative AI) to score each topic or trend (e.g., as well as a subset of representative documents) on a scale of (e.g.) 1 to 5 for a diverse set of qualitative and/or quantitative criteria. Examples of criteria include relevance to e.g., price, value, complaints, and other traditional marketing research criteria. This process of assigning numerical ratings to qualitative (or quantitative) criteria yields additional quantitative information by which to group and sort data. The use of e.g., generative AI to score topics/trends can take a variety of forms. In some embodiments this can involve scoring less than every post/article. For example, some approaches can involve scoring topics/trends, their superordinate clusters, and a subset of representative documents. This may yield many of the benefits described in the current disclosure while using a fraction of the data used when scoring every single post/article.

Step 4 can be creating predictive models of topic evolution. This can involve deriving predictors of interest via interrogation of the dataset/database, estimating velocity trends of topics or segments using ensemble modeling, and/or verifying model accuracy via a holdout sample. Various embodiments of time series graphs can help users to see what items are growing or shrinking with respect to market analysis. Various AI/ML tools can be used to create these models of topic evolution, such as time series models, deep neural networks like multivariate LSTM (Long Short-Term Memory), and others.

Step 5 can be enhanced data analysis. This can include dimensionality reduction techniques (possibly including principal component analysis) to identify strategic themes, audience profile (i.e., psychographic and demographic characterizations of the users associated with individual trends and/or trend clusters), and identifying key drivers of interest. This step can comprise the use of LLM, AI/ML tools to identify themes, profiles, and key drivers.

Step 6 can be populating a user dashboard that can convey actionable insights to lay and expert market analysts in a digestible format (i.e., with an intuitive and responsive UI/UX). This can include generating a “baseball card” summary for each topic, creating “top trends” reports, and enabling a search function to interrogate data directly with user-defined queries (e.g., “show all problems related to EV batteries in the last 6 months”). Further embodiments can comprise a website, portal, dashboard, etc. that lets users view trends or other data. Generative AI tools can help create and enhance these embodiments, especially by generative abstractive summaries, automatically articulating insights regarding how topics and trends are related (either through language or statistics) and helping to answer user questions through dialogue. Dashboard/baseball cards may have client options for ways to sort data, filter, and summarize data. Receiving and tracking client options for display of data can provide one way of monitoring feedback on client preferences. Using AI for this step 6 can save hundreds of person hours. Unstructured data is by definition difficult to manipulate in an ordered fashion. But AI can achieve this analysis and create illustrative figures of data quickly. Critically, generative AI can help to create run-time summaries and visualizations for users that may not have been anticipated in advance. In this way, generative AI, and LLMs in particular, can empower both the initial data models as well as their dynamic presentation to users.

Step 7 can be crafting a narrative(s) for client presentation. This can involve senior-level consultants defining an executive summary of the findings, describing key trends for a client to monitor, and/or an in-person client presentation. AI (in particular generative AI) can assist in the presentation/storytelling process by generating multiple initial drafts of summaries of key trends. The process of sensemaking in Marketing Research has long required in-depth analysis by both junior and senior level analytical teams. Leveraging AI in embodiments of the present disclosure does not entirely divorce humans from the sensemaking exercise but it largely automates much of the lower-level analytic tasks. This frees up senior level researchers to focus more effort on storytelling, which is what clients crave.

Step 8 can be an ongoing step, such as a monthly dashboard refresh. This can comprise providing the client with ongoing live updates of trend developments e.g., in an automated fashion via a software deliverable.

AI/ML embodiments under the present disclosure preferably utilize unsupervised learning. Inputs for AI/ML under the present disclosure can be a variety of data contained in, or related to, social media posts or new items. For many embodiments, desired outputs include greater sales by a client or successful marketing campaigns. Using such outputs, which can be hard to measure, or may be impacted by market forces beyond the control of the client, can make supervised learning difficult. As a result, unsupervised learning may be more amenable to many embodiments. However, LLMs used in modelling topics and trends may benefit from fine-tuning or transfer learning based upon annotated data or results.

One example of an unsupervised learning embodiment could be using contextualized text embeddings followed by dimensionality reduction with UMAP (Uniform Manifold Approximation and Projection) and clustering with HDBSCAN (hierarchical density-based spatial clustering for applications with noise), two common options for BERTopic. Other embodiments could use other examples of unsupervised learning, such as one or more of the following techniques: expectation maximalization, K-Means, cobweb hierarchic clustering, shared neighbor clustering, and constrained clustering. Supervised learning embodiments can be used as well. One such embodiments could employ fine-tuned deep neural networks with a transformer-based architecture with a classification “head.” Other non-limiting examples of supervised learning embodiments could include one or more of the following techniques: Support Vector Machine (SVM), logistic regression, naive Bayes, naive Bayes simple, logit boost, random forest, multilayer perception, J48, and Bayes net. Certain embodiments may combine unsupervised and supervised techniques. For example, certain embodiments may involve unsupervised learning for the task of identification of topics and the classification of texts to topics is unsupervised. But supervised learning could be used for trend modeling and prediction. For example, once topics in a dataset are known, predicting which topics will increase or decrease over a given timeframe can be a supervised learning problem.

Generally, unsupervised learning refers to ML methods that attempt to discover hidden patterns in data without the benefit of prior results/knowledge, e.g., training sets with known desired outputs. K-Means, for example, attempts to cluster data together based on unlabeled input and a preset number of clusters. While supervised learning utilizes labeled data to train a model, unsupervised learning instead focuses on features that emerge from the data. When using unsupervised learning, targeted outputs are less important as the algorithm will try to find relationships and patterns amongst the input data based on the input data alone. Clustering is the typical desired output of unsupervised learning, which can refer to data “clusters,” such as the topics or labels discussed above. Clustering can reveal underlying patterns within a set of data that are not noticeable to a human observer.

Certain embodiments of research server 35 (and/or user devices 60, 65) include an AI/ML engine used to discover clusters within social network post data and/or new items. Unsupervised learning can be utilized to improve the topic creation aspects described above.

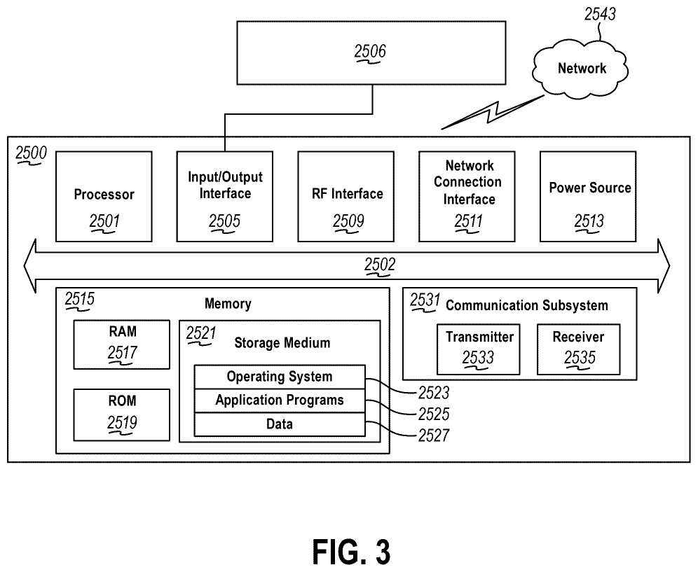

FIG. 3 illustrates an embodiment of various computing devices within market research system 10 of FIG. 1, or components thereof e.g., research server(s) 35, user device(s) 60, 65, or other computing or smart devices described herein. FIG. 3 shows a schematic block diagram of a computing device 2500 (or components thereof) according to certain embodiments of the present disclosure. System 2500 can be used to analyze and/or optimize: the functionalities described with respect to e.g., research server(s) 35, user device(s) 60, 65, or to perform ML-related tasks and analyses as described herein.

Computing device 2500 includes processor 2501 that is operatively coupled via a bus 2502 to an input/output interface 2505, a power source 2513, a memory 2515, a RF interface 2509, network communication interface 2511, and/or any other component, or any combination thereof. The level of integration between the components may vary from one embodiment to another. Further, certain computing devices 2500 (or components thereof) may contain multiple instances of a component, such as multiple processors, memories, transceivers, transmitters, receivers, etc.

The processor 2501 is configured to process instructions and data and may be configured to implement any sequential state machine operative to execute instructions stored as machine-readable computer programs in memory 2515. Processor 2501 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 2501 may include multiple central processing units (CPUs), and/or multiple graphics processing units (GPUs) and/or multiple other similar components.

In the example, input/output interface 2505 may be configured to provide an interface or interfaces to an input/output device(s) 2506, such as a screen, keyboard, indicator light, keypad, touchscreen, or other input or output device. Other examples of an output device include a speaker, a sound card, a video card, a display, a monitor, a printer, an actuator, an emitter, a smartcard, another output device, or any combination thereof. An input device may allow a user to capture information into system 2500. Other examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2513 is structured as a battery or battery pack. Other types of power sources, such as an external power source (e.g., an electricity outlet), photovoltaic device, or power cell, may be used. The power source 2513 may further include power circuitry for delivering power from the power source 2513 itself, and/or an external power source, to the various parts of computing device 2500 via input circuitry or an interface such as an electrical power cable.

Memory 2515 may be configured to include memory such as random access memory (RAM) 2517, read-only memory (ROM) 2519, programmable read-only memory (PROM), erasable programmable read-only memory (EPROM), electrically erasable programmable read-only memory (EEPROM), magnetic disks, optical disks, hard disks, removable cartridges, flash drives, other storage medium 2521, and so forth. In one example, the memory 2515 includes one or more application programs 2525, an operating system 2523, web browser application, a widget, gadget engine, or other application, and corresponding data 2527. Memory 2515 may store, for use by the computing device 2500, any of a variety of various operating systems or combinations of operating systems. An article of manufacture, such as one including a simulation system or communication system may be tangibly embodied as or in memory 2515, which may be or comprise a device-readable storage medium.

Processor 2501 may be configured to communicate with an access network 2543 (e.g., network 25 of FIG. 1) or other network using the RF interface 2509 or network connection interface 2511. The RF interface 2509 or network connection interface 2511 may comprise one or more communication subsystems and may include or be communicatively coupled to an antenna. In the illustrated embodiment, communication functions of the RF interface 2509 or network connection interface 2511 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

Market research system 10 of FIG. 1 can perform ML-based methods such as such as described herein, for e.g., analyzing what groupings of social network or news data. Optimizing these factors may lead to savings over time due to less need for man hours spent during the process. In certain embodiments market research system 10 (e.g., in research servers 35) can comprise a ML/AI engine for training or implementing a ML/AI model, such as any AI/ML model described with respect to method 200 of FIG. 2. The architecture of an ML model (e.g., structure, number of layers, nodes per layer, activation function etc.) may need to be tailored for each particular use case. For example, properties to vary can include e.g.: social network source; text data from social media posts, time, date, newspaper source, and a variety of other factors. These may all need to be considered when designing the ML model's architecture. While unsupervised learning embodiments are preferred for e.g., certain aspects of step 3 of method 200, other embodiments may comprise other types of ML, e.g., supervised learning, semi-supervised learning, etc.

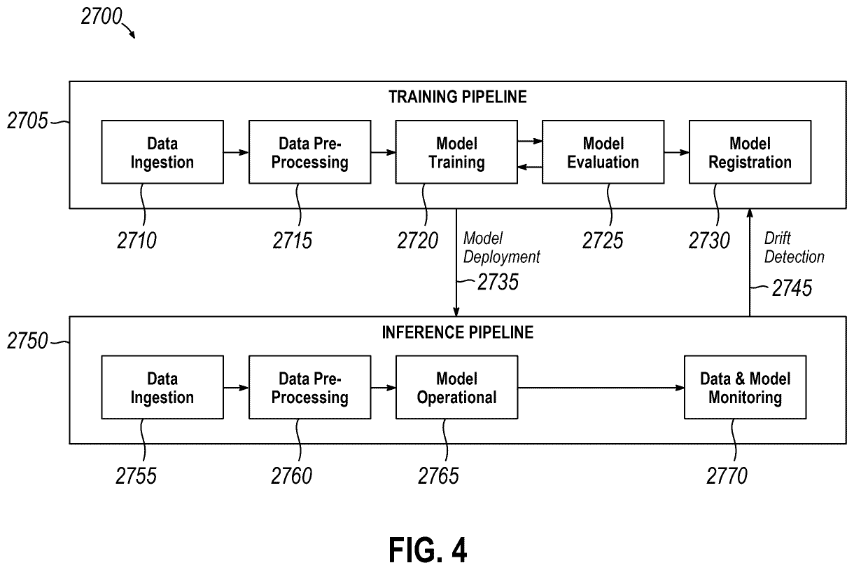

Building an AI/ML model includes several development steps where the actual training of the ML model is just one step in a training pipeline. An important part in AI/ML development is the AI/ML model lifecycle management. One embodiment of a model lifecycle management procedure 2700 is illustrated in FIG. 4. The model lifecycle management comprises two pipelines: a training pipeline 2705 and an inference pipeline 2750.

At 2710 in the training pipeline 2705, data ingestion 2710 occurs, which includes gathering raw (training) data from a data storage. After data ingestion 2710, there may also be a step that controls the validity of the gathered data. At 2715 data pre-processing occurs, which can include feature engineering applied to the gathered data. This may involve, e.g., data normalization or data formatting or transformation required for the input data to the AI/ML model. After the ML model's architecture is fixed, for supervised learning, it should be trained on one or more datasets. At 2720 model training is performed in which the AI/ML model is trained with the raw training data. To achieve good performance during live operation in a system (the so-called inference phase), the training datasets should be representative of actual data the ML model will encounter during live operation. The training process often involves numerically tuning the ML model's trainable parameters (e.g., the weights and biases of the underlying neural network (NN)) to minimize a loss function on the training datasets. The loss function may be, for example, based on a sales data, labeled groupings of data, or other output. The purpose of the loss function is to meaningfully quantify the reconstruction error for the particular use case at hand. At 2725 model evaluation can be performed where the performance is benchmarked to some baseline. Model training 2720 and evaluation 2725 can be iterated until an acceptable level of performance is achieved. At 2730 model registration occurs, in which the AI/ML model is registered with any corresponding data on how the AI/ML model was developed, and e.g., AI/ML model evaluation data. At 2735 model deployment occurs, wherein the trained/re-trained AI/ML model is implemented in the inference pipeline 2750.

Data ingestion 2755 in the inference pipeline 2750 refers to gathering raw (inference) data from a data source. Data pre-processing 2760 can be essentially identical/similar to the data pre-processing 2715 of the training pipeline 2705. At 2765, the operational model received from the training pipeline 2705 is used to process new data received during operation of e.g., market research system 10 of FIG. 1 or components thereof. At 2770 data and model monitoring is performed. Here the inference data is analyzed to determine whether the inference data are from a distribution that aligns with the training data, as well as monitoring model outputs for detecting any performance, or operational, variance or drifts. The variance or drift is used at 2745 (drift detection) to update the AI/ML model registration.

The training process can utilize an optimization algorithm. Examples include e.g., continuous function optimization algorithms, differentiable objective function algorithms, gradient descent algorithms, maxima/minima, learning rate, and others. Training can also utilize different model architectures, e.g., DNNs, feedforward neural networks, convolutional neural networks (CNN), recurrent neural networks (RNNs), and others. Possible steps, depending on the algorithm chosen, can include, e.g., a feedforward step, a back propagation step (e.g., for deep neural networks), and a parameter optimization step. These steps can be described using a dense ML model (i.e., a dense NN with a bottleneck layer) as an example. Dense NN may involve too many parameters, and therefore may not always be ideal for embodiments of the present disclosure.

Feedforward: A batch of training data, such as a mini-batch, (e.g., several downlink-channel estimates) is pushed through the ML model, from the input to the output. The loss function is used to compute the reconstruction loss for all training samples in the batch. The reconstruction loss may be an average reconstruction loss for all training samples in the batch.

The feedforward calculations of a dense ML model with N layers (n=1, 2, . . . ,N) may be written as follows: The output vector a [n] of layer n is computed from the output of the previous layer a [n−1] using the equations:

$${z}^{[ n ]} = {W}^{[ n ]} \cdot {a}^{[ n - 1 ]} + {b}^{[ n ]} , {a}^{[ n ]} = g ( {z}^{[ n ]} ) \qquad ( 1 )$$

In the above equation, W [n] and b [n] are the trainable weights and biases of layer n, respectively, and g is an activation function applied elementwise (for example, a rectified linear unit).

Back propagation (BP): The gradients (partial derivatives of the loss function, L, with respect to each trainable parameter in the ML model) are computed. The back propagation algorithm sequentially works backwards from the ML model output, layer-by-layer, back through the ML model to the input. The back propagation algorithm is built around the chain rule for differentiation: When computing the gradients for layer n in the ML model, it uses the gradients for layer n+1.

For a dense ML model with N layers the back propagation calculations for layer n may be expressed with the following well-known equations:

$$\frac{\partial L}{\partial {a}^{[ n ]}} = {[ {W}^{[ n + 1 ]} ]}^{T} \cdot \frac{\partial L}{\partial {z}^{[ n + 1 ]}} \qquad ( 2 )$$

$$\frac{\partial L}{\partial {z}^{[ n ]}} = \frac{\partial L}{\partial {a}^{[ n ]}} * {g}^{{[ n ]}^{′}} ( {z}^{[ n ]} ) \qquad ( 3 )$$

$$\frac{\partial L}{\partial {W}^{[ n ]}} = \frac{\partial L}{\partial {z}^{[ n ]}} \cdot {[ {a}^{[ n - 1 ]} ]}^{T} \qquad ( 4 )$$

$$\frac{\partial L}{\partial {b}^{[ n ]}} = \frac{\partial L}{\partial {z}^{[ n ]}} \qquad ( 5 )$$

where * here denotes the Hadamard multiplication of two vectors.

Parameter optimization: The gradients computed in the back propagation step are used to update the ML model's trainable parameters. An approach is to use the gradient descent method with a learning rate hyperparameter (α) that scales the gradients of the weights and biases, as illustrated by the following update equations:

$${W}^{[ n ]} = {W}^{[ n ]} - α \cdot \frac{\partial L}{\partial {W}^{[ n ]}} \qquad ( 6 )$$

$${b}^{[ n ]} = {b}^{[ n ]} - α \cdot \frac{\partial L}{\partial {b}^{[ n ]}} \qquad ( 7 )$$

It is preferred to make small adjustments to each parameter with the aim of reducing the average loss over the (mini) batch. It is common to use special optimizers to update the ML model's trainable parameters using gradient information. The following optimizers are widely used to reduce training time and improving overall performance: adaptive sub-gradient methods (AdaGrad), RMSProp, and adaptive moment estimation (ADAM).

The above process (feedforward, back propagation, parameter optimization) is repeated many times until an acceptable level of performance is achieved on the training dataset. An acceptable level of performance may refer to the ML model achieving a pre-defined average reconstruction error over the training dataset (e.g., normalized MSE of the reconstruction error over the training dataset is less than, say, 0.1). Alternatively, it may refer to the ML model achieving a pre-defined value chosen by a user.

In some implementations, a function F(·) may be generated by a ML process, such as, for example, supervised learning, reinforcement learning, and/or unsupervised learning. It should further be understood that supervised learning may be done in various ways, such as, for example, using random forests, support vector machines, neural networks, and the like. By way of non-limiting example, any of the following types of neural networks that may be utilized, including, deep neural networks (DNNs), convolutional neural networks (CNNs), and recurrent neural networks (RNNs), or any other known or future neural network that satisfies the needs of the system. In an implementation using supervised learning the neural networks may be easily integrated into the hardware described in market research system 10 of FIG. 1 (e.g., in the form of simple vector-matrix multiplications).

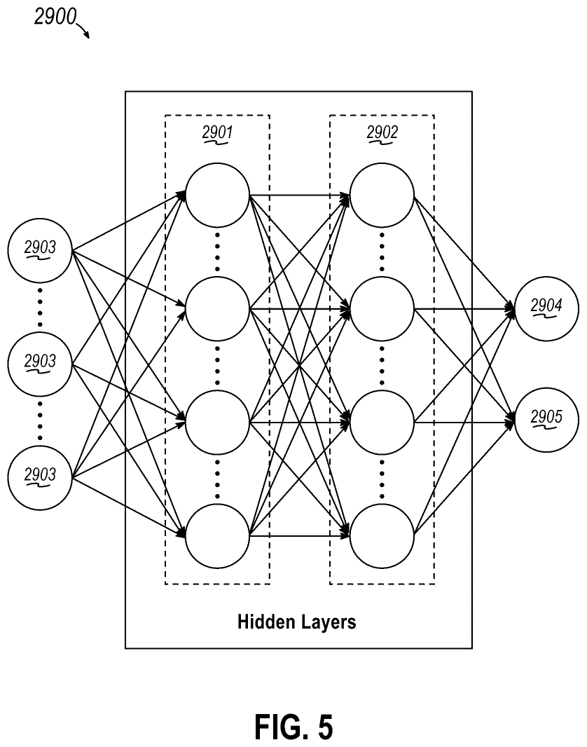

Referring now to FIG. 5, an example NN 2900 (e.g., DNN) is shown. In some implementations, and as shown, the neural network 2900 may include two hidden layers represented by dashed boxes 2901 and 2902. In one implementation, the inputs 2903 may be fed into the NN 2900. Next, the inputs 2403 may go through a set of hidden layers (e.g., 2901 and/or 2902). Once the inputs 2903 pass though the hidden layers 2901 and/or 2902, they may be output (e.g., as an output layer) as e.g., sales data 2904; grouping/cluster metrics 2905; or another output valuable for e.g., market analysis. Possible inputs can include e.g.: news or data sources, keywords, type of data, social network metadata, and a variety of other factors.

As should be understood by one of ordinary skill in the art, in order for the NN 2900 to output proper a proper analysis, it should be trained properly (e.g., with a collection of samples) to accurately extract the likelihood values. If not trained properly, overfitting (e.g., when the NN memorizes the structure of the preambles but is unable to generalize to unseen preamble characteristics) or underfitting (e.g., when the NN is unable to learn a proper function even on the data that it was trained on) may happen. Thus, implementations may exist that prevent overfitting or underfitting, involving a set of well-engineered features that must be extracted from the preamble characteristics.

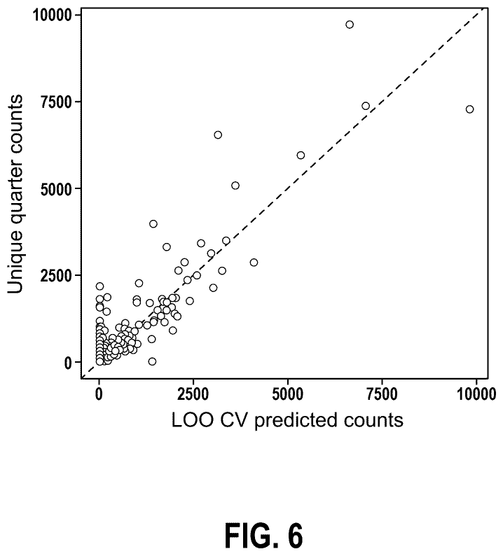

FIG. 6 shows an example temporal analysis and trend extraction under the present disclosure. This example temporal analysis and trend extraction may include a goal of predicting a number of social media posts for latent topics in Q1 of 2022, or another time period. The method in this example may include fitting one or more varying models to unique time windows and/or combining the one or more varying models through Bayesian model averaging. The results of the temporal analysis and trend extraction may include posterior weights for one or more time frames, variance percentages, or other relevant result.

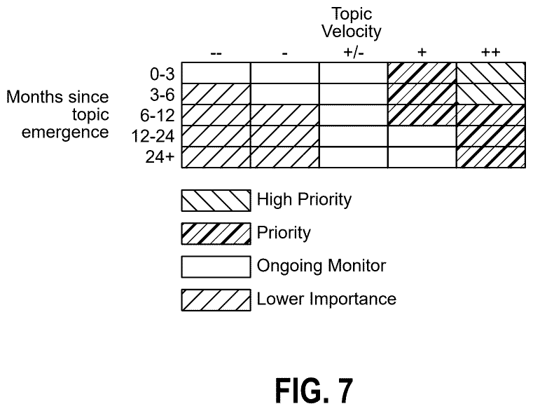

FIG. 7 shows an example model of topic trend data under the present disclosure. Once one or more sets of topics are prepared for review, the age of one or more topics may be assessed. The model may include illustrating one or more trend data of the one or more topics. The one or more trend data illustration may be modeled with descriptive statistics around the evolution of mention for each topic to determine which topics may be prioritized for further analysis.

The systems and methods disclosed herein may include data sourcing and querying which may include cleaning, filtering, quality optimization, etc.; topic modeling/trend extraction which may include topic busting, etc.; trend characterization (for search, ranking, filtering, sorting, sensemaking, and analysis) which may include topic labeling, summary, extraction, representation, prediction, emotion, participation, uniqueness, volume, moral foundations, GPT based ratings, opportunity-relayed scoring with LLMs (users may define their own), or other characterization; sensemaking, UI functionality-a picture of system architecture, a mockup of a GUI; other characteristics which may include artificial focus group, “who” analysis, topic networks (sensemaking and/or temporal), etc.

In some embodiments, generative AI may clean the data and remove unrelated context, generate individual names for each topic, score each topic on a variety of descriptive measures for further analysis, classify each topic into framework for analysis and reporting, and/or other processes. In some embodiments, statistical routines leveraging Ensemble modeling may predict growth potential or other metrics for one or more topics. In some embodiments, the systems and methods disclosed herein may calculate a topic potential score to determine a value for the strategic potential of a topic. This may allow clients to empirically assess topics relative to other topics.

In some embodiments, the systems and methods disclosed herein may include unstructured data analysis. Generally, unstructured data may include data which may be derived as a result of other specific actions. For example, a consumer researching a new automotive purchase online may defacto generate a great deal of digital data regarding the specific brands they chose to research (or not) and/or the length of time that they spent in each activity. There may also be great value in understanding which comments or questions the consumer might pose on social media as they work through their purchase decision. This data may be unstructured or rather may not automatically exist in a set “row and column” format. Rather this data may be generated in many different formats based upon the specific actions of the consumer. This lack of order within a dataset generally may allow intervention prior to analysis or reporting. In some embodiments, the approach may initially leverage a wide-ranging corpus of digital data collected at scale. Comprising a dataset may include: Social media—this may encompass message boards and blogs from platforms such as facebook, Instagram, Reddit, Tumblr, and other sources; Twitter—A sample of twitter mentions may be included in an analysis; Consumer ratings and review data; Publicly available News articles and Press Releases; or other sources.

In some embodiments, a data collection pipeline may be augmented with additional relevant data sources. For example, ratings and reviews may be particularly relevant for cosmetics. Therefore, capturing information from a manufacturer's own retail site may be desired as part of any project. This may be a smaller portion of data collection with likely many other data sources being consistent between various projects. In some embodiments, adhering to privacy standards may be desired, like only accessing publicly available data. Analyzed data may also be anonymized. This may ensure that analysis tools will not be used in a manner to surveil or uncover individuals based upon their digital footprint.

Given the dynamic nature of social media, where platforms frequently emerge and fade, a production pipeline and one or more modeling routines may accommodate variability in input sources over time. Furthermore, robust trend monitoring may be ensured by maintaining access to a one-year, five-year, ten-year, or other timeframe data archive, which may enable effective tracking of trend evolution over time.

In some embodiments, a production pipeline and one or more modeling routines may be built assuming that there will be variability in input sources over time. A stable consistent dataset may not be required for a dataset. In some embodiments, source data may be purchased from one or more third-party aggregators.

In some embodiments, one or more analyses may focus on a particular category which may be interrogated for analysis. An example would be electric vehicles which may include electric automobiles and hybrid vehicles powered by both petroleum and electricity. Also included in the definition may be electric motorcycles, scooters, bicycles, etc. The category for analysis may also include adjacent areas to EVs such as charging (in home and out of home). Political and business issues relevant to EVs may also be included.

In some embodiments, forming a custom definition of a category may include creating a series of Boolean searches which query a broader corpus of unstructured social media or other data and identify social media mentions which are relevant to the category. The queries may use a series of “IF”, “AND”, “OR”, and/or “NOT” operators to craft a dataset. Similar language may be used in some queries to filter inappropriate content. Iteratively pulling small test datasets may be useful in developing a dataset.

In some embodiments, topic modeling and refinement may be performed in several stages, in order to extract trends and meaning from noisy, unstructured text data

In some embodiments, initial topic models may include: 1. Transformer-based language models that may be used to create contextualized document embeddings; 2. Embeddings may be reduced in dimensionality (using algorithms such as UMAP or PCA); 3. Reduced embeddings may be clustered to form topics (using HDBSCAN, k-means, or agglomerative clustering). Other approaches may be suitable as well.

Recuperating outlier documents: In some embodiments, outlier documents may be generated (those that do not fall within an cluster of sufficient size in the initial model). Outlier documents may represent interesting, domain-relevant content. A processing of outlier recuperation may be employed. This process may include: 1. A separate topic model that may be fit for outlier documents, and resulting topic embeddings may be compared to those in the main model using a suitable distance metric (e.g., cosine similarity); and/or 2. Outlier topics that are found to be sufficiently similar to those in the main model may be recuperated by joining their documents to the recipient topics in the main model and/or updating representations.

Partitioning Large Topics to Extract Nuanced Subtopics: In some embodiments, topic sizes (number of documents per topic) may be non-normally distributed, with a small number of topics containing a substantial fraction of documents. To retrieve more nuanced, actionable content for trend analysis, topic representations may be partitioned. This may include:
1. Separate topic models may be applied to each topic exceeding a given threshold volume; and/or
2. Subtopics of sufficient size may be joined to the main model based upon custom algorithms, which may consider: A) the similarity of subtopics to topics in the main model, B) the volume of the source and/or recipient topics in the submodel and main model, and/or C) the coherence of sub-topics amongst themselves; and/or 3. This partitioning process may be iterated to further refine topic representations.

Integrating/Pruning Small and Stale Topics: In some embodiments, main topic models may also generate a large number of small topics, often with posts distributed across time. Topics with low volume and/or infrequent recent posts may be pruned or merged into larger topics. This may include: 1. Small topics with sufficient recent posting frequency may be compared to larger topics based upon cosine similarity (or another similar metric); 2. Small topics that are sufficiently similar to larger topics (or to other small, recent topics) may be iteratively merged until criterion size and distance threshold are met; 3. Small topics that cannot be integrated may be discarded from the model, along with their associated documents.

Filtering Topic Relevance Using LLM/Generative AI: Topics may vary in their domain-relevance, with some themes only tangentially related to the target domain. In some embodiments, large language models powered by generative AI may provide an efficient solution for triaging irrelevant topics without losing counter-intuitive associations that similar filtering methods might fail to recognize. This may include: 1. Custom generative-AI prompts/queries may be used in conjunction with existing APIs (e.g., for ChatGPT, Claude) to determine a relevance score for each topic; and/or 2. Topics and associated documents that are not highly domain-relevant may be dropped from the model (either fully automated or optionally with human-in-the-loop discretion).

Evaluating Topic Affective Properties: Topics may evoke a variety of responses in social media users. In some embodiments, a variety of approaches may be used to detect nuanced attitudes and orientations towards each topic. These may include: 1. Sentiment analysis algorithms may be employed to assesses the frequency and extremity of positive, neutral, and negative sentiment towards topics; 2. Emotion detection and analysis may be used to gauge the strength of emotional responses associated with topics (e.g., happiness, sadness, anger, fear, disgust, surprise); and/or 3. The extended moral foundations dictionary may be used to identify moral attitudes latent within topic discourse (e.g. harm/care, authority, sanctity, equality).

Evaluating Topic Connectedness: In some embodiments, graph-based algorithms may be used to extract connections between topics for further analysis. This may include: 1. A co-occurrence matrix (i.e., employed as an adjacency matrix) may be used to transform the data into a network graph representation, in which topic nodes are linked; 2. Graph-based properties of nodes, such as their degree and centralities, may be extracted to identify topics that connect distinct domains of discourse; and/or 3. Community-detection algorithms may identify groups of associated topics.

Topic User Profiling and Comparison: In some embodiments, some data sources may include user-based information, such as demographic data and posting frequency. This information may be used to further profile topics and examine their unique relevance to different users. This may include: 1. Topics may be ranked by appeal to different user groups; 2. Topics may be sorted based upon regional/geographic relevance; and/or 3. Heterogeneity of topic user-base may be assessed (i.e., the extent to which small, vocal groups contribute versus larger, diffuse sets of users).

Temporal Analysis and Trend Extraction: In some embodiments, the frequency of posts about topics over time may be analyzed using generalized linear models (GLMs) and/or time-series models such as hidden Markov models (HMMs). Several components may be integrated in a holistic evaluation of trend volume, dynamism, and uniqueness. This may include: 1. Aggregating the data; 2. Generating models; and/or 3. Blending the models.

Temporal Analysis and Trend Extraction: Data aggregation: In some embodiments, the systems and methods disclosed herein may begin with raw data featuring the text of each social media post, the source of that post, a positive/neutral/negative sentiment score, an emotional valence score along 7 dimensions (anger, disgust, fear, joy, sadness, surprise, and neutral), indicators of whether that post is original or copied (i.e., different columns for different platforms), and/or indicators of author (again, unique columns for different platforms). The raw data may then be aggregated into time periods of interest, such as months or quarters, for each topic. Once data has been aggregated over, e.g., months, additional data sets may be generated that may be further aggregated over various time windows. These windows may share a common ending point but vary along starting point. For example, data may be generated that aggregate over the most recent 24, 12, 6, 3 months and/or other timeframes.

In some embodiments, predictors of interest may be derived when generating final sets. These predictors may include: linear slope of post counts, the log of unique posts, proportion of topics with non-zero sentiment, proportion of unique Twitter posts, proportion of Twitter posts that are Retweets, proportion of unique Tweets that are generated by unique posters, and/or average emotional valence across the aforementioned dimensions. A final set of predictors may be z-scored before modelling. In some embodiments, other social media apps and/or sites may be used other than Twitter.

Generate models: Once the data is aggregated, a GLM is generated for each set. In some embodiments, Bayesian zero-inflated-Poisson (ZIP) models may be used but could be other or additional model types. These models are distributional models, meaning they can estimate both the mean and rate of zero inflation as a function of predictors. These models may be estimated via MCMC sampling in Stan probabilistic software via the brms package in R statistical software. In some embodiments, unit-Cauchy priors may be placed on all coefficients pertaining to effects of. In some embodiments, other alternative priors may be used.

Blend the models: Once all models are estimated, the models may be combined via posterior stacking. Stacking weights may be obtained via pseudo-Bayesian-model-averaging (BMA) and/or other methods. Predicted counts may be generated for each topic via approximated leave-one-out cross-validation and these counts may be weighed according to the pseudo-BMA weights. Then the average of these predictions may be taken to generate a final set of predicted counts. In addition to blending GLMs, in some embodiments, predictions of trends via HMMs may be generated. Data may be aggregated over months, quarters, etc., by topic for an HMM (as opposed to the two-stage aggregation that we use for GLMs).

In some embodiments, Generative AI may be used to categorize topics on a series of key measures such as: creating topic summaries of various length and detail; category relevance; demonstrating an unmet need; drawing a connection between cultural trends and category; drawing a connection between consumer trends and current category; mentioning other products; suggesting a sales opportunity; suggesting a marketing opportunity; focusing on popularity with, or use by, a particular customer demographic; focusing on broader social, political and cultural factors; and/or others. In some embodiments, Generative AI may be used to provide names for thousands of topics which may be generated via a topic modeling exercise. Each topic may have a unique name or label for reference throughout an analysis. In some embodiments, Generative AI may be used to provide summaries of the text of one or more topics. The text within the one or more topics may be very lengthy and difficult to digest. Generative AI may be used to provide these summaries. Generative AI may also score various pieces of text on a numeric scale.

In some embodiments, generative AI may deliver output in a tabular format. Having results delivered in a table may allow the creation of a structured database whereby target text is appended with columns of data which may be generated by Generative AI. This may bring a structure and order to unstructured data which may aid analysis. Graphical depiction of the results is may also be enabled by the tabular nature of the data

In some embodiments, the API for the various Generative AI tools may be integrated into a pipeline. This may enable generative AI in a production environment. The usage of APIs in a production pipeline may also allow updating of results in near real time. This may allow updates of data and analysis in an automated.

To discover non-obvious insights at scale, key elements of this process may include: Identification of relevant trends to be considered for examination; and/or Sifting through a universe of topics to gauge the “Newness” of topics. This framework may allow for customization which may aid in the different needs of different clients and/or greater topic understanding.

In some embodiments, a production pipeline may allow new topic modeling approaches to be integrated into the system with minimal effort.

In some embodiments, the systems and methods disclosed may assess each topic on an equal footing based upon the creation of a composite measure. This composite measure may be a weighted metric which may incorporate the following measures for each topic: Trend Velocity, Reliability/regularity of trend, Topic liking score as generated by Generative AI, Topic uniqueness score as generated by Generative AI, and/or other measures. Other measures can be included in this score as well based upon the dynamics of the category which is being investigated. For example, variety may be more important in fashion than in Ready to Eat Cereal.

In some embodiments, clients may have the option to apply custom weights to their model to perform simulations on the results. For example, a client might want to investigate how a change in strategy to focus solely on uniqueness would impact their target opportunities. This may be offered to clients as part of a user dashboard which may allow “On the fly” simulation of different prioritization strategies. Understanding the audience behind a trend will be a very important element of our offer.

In some embodiments, the systems and methods disclosed herein may include looking at the relationship of topics within the database. For example, it may beneficial to identify topics which share a positive or negative correlation in the marketplace. It may also be beneficial to infer the audience behind each topic based upon where mentions of the topic appear. In some embodiments, the underlying story behind the topics may include investigating via a series of Tertile analyses and crosstabs. This may include calculating the relative ranking (top third, middle third, bottom third) of each topic on a variety of measures and comparing them across different variables. An example of this would be to compare topics which scored in the top third of observed on uniqueness and the top third of observed liking scales. In some embodiments, the calculation may include adding a time element to the analysis as well and reviewing the topics progression over time. This may include looking at a particular topic and gauging its' performance against a peer set over 3, 6, and 12 month or other time periods.

In some embodiments, generative AI tools may interrogate a larger set of data in the following manner: Identify key drivers of consumer appeal, Detailed exception reporting, Provide summary narratives to help understand the performance of various topics, Compare and contrast topics within a dataset, Identify major themes across a broad number of topics, or others. Generative AI may form a “virtual team” of junior analysts who can sift through the data uncovering insights for consideration.

Ongoing delivery of electronic dashboards: In some embodiments, a dashboard functionality may add a “real time” element where clients can review updated results from an analysis over time. The dashboard may also offer analytic capabilities where clients can perform basic simulations based upon their needs. Examples of this may include: Structuring different cross tabs between variables within our dataset, Exception reporting of different measures within our database, Simple graphics to illustrate trend evolution over time, or others.

Detailed “Who” analysis. In some embodiments, detailed profiles may be generated of individuals who generate content in a corpus of information to bring deep understanding of the wants and needs of different user groups within society. Marketers aim to deliver messages to specific audience segments and this could allow them to utilize a technique to understand which messages would be most appealing to different segments. In some embodiments, usage of social media data could bring a novel opportunity to profile individuals based upon their posts or mentions which are outside of our area of interest. For example, social media timeline of users who favor a particular new product could be scraped in order to better understand their feelings on the political spectrum or other areas. This could provide a “Surround sound” view of the customer which would be very helpful in understanding their motivations.

Virtual focus groups. In some embodiments, LLM may be trained on source material which may be relevant to a target category and hence create a virtual consumer for clients to interview. For example, a model could be trained from a database of 6 MM social media mentions pertaining to the Electric Vehicle category and develop a sort of “Chatbot” based upon the information. This could allow clients to quiz the tool and gain a better understanding of the content contained in our database. This model could also be improved based upon learnings from the “Who” analysis mentioned above. One or more personas could be generated based upon specific user groups or demographics and used to represent different segments of our audience.

Topic Networks. In some embodiments, examining the topics relative to the peers and quantifying networks of various topics based upon related characteristics may be beneficial. This could allow a better understanding the similarities between different topics in a graphical nature. These visual depictions of topic networks could help illuminate similarities between topics which might otherwise remain unknown.

### Unstructured Data Compared to Traditional Survey-Based Research:

| | Unstructured Data | Traditional Survey-based Research |
|---|---|---|
| Framework | Listen to natural content in real time | Compensated respondents answer preselected |
| | | questions in staged interview |
| Study Cadence | Continuous | Episodic |
| Data Capture | API Access to existing data sources | Online surveys |
| Data Storage | Large databases with Cloud Storage | “Little data” fits on hard drive |
| Analyst Tools | Coding languages such as R or Python | Typically Excel. Limited use of SAS/SPSS |
| Analytical Techniques | Al/ML, Natural Language Processing | Simple crosstabs of data, profile of segments, |
| | (NLP), Bayesian Analysis | descriptive statistics |
| Client Deliverables | Electronic delivery via dashboards | PowerPoint with limited Data Tabs |
| | with summary results presentation | |

In some embodiments, vast datasets of unstructured data may be interrogated using novel analytic techniques. Key themes or topics may be identified resident in the data. Each topic may be analyzed with a detailed profile developed. Detailed personas of each topic may be created with key elements such as forecasted trajectory (growth/decline), uniqueness, category relevance, etc. An opportunity score may be developed for each topic. Through delivery of an automated dashboard may allow for tracking of an evolution of previously-identified themes on an ongoing monthly basis. Scorecards may be updated to track performance against manufacturer priorities.

In some embodiments, a dataset of unstructured data may be queried using intelligent Boolean queries. Then a generative AI may cleanse, edit, and refine the dataset. Generative AI may also perform deep data enrichment and classification to the dataset. Transformer-based LLMs may distill data into relevant topics. One or more time series models may forecast topic evolution and/or trends. Kairos may provide expert in-person analysis of trends and opportunities. A self-serve dashboard displaying relevant data may be provided for client data interrogation.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled-whether in a single stage or in multiple stages—so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### CONCLUSION

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be affected to the particular embodiments by those of skill in the art without departing from the scope of the description, which is defined solely by the appended claims.

What is claimed is:

1. A system for predicting consumer and market behavior for an industry e.g., with a particular focus on uncovering deep insights at scale, the system comprising:
one or more research servers configured to access one or more social networks and one or more data sources, and further configured to perform one or more of:
database curation, such as create custom queries, populate database from various content sources, or validate database structure, and/or incorporate proprietary methods for processing data from unique data sources such as X (formerly known as twitter) and Reddit, such processing ensuring insights are maintained while facilitating analysis of the content;
ensure data hygiene e.g., with generative AI, such as removing irrelevant content, editing for non-text content, or deduplicating data and hold aside duplicate records;
establish data hierarchy, such as leverage transformer based LLMs to add structure to database, utilize LLMs to create topic names, or enrich data with content generated by LLMs, which may comprise e.g., the inclusion of proprietary routines to the output of topic modeling results to ensure that the results are not skewed due to an inappropriate distribution of topics by size, and/or overly large topics are decomposed into smaller topics while unduly small topics are merged with other like topics to ensure adequate sample size, thereby enhancing the usability of the topic landscape created by the approach and ensures that the results are balanced and representative of the broader dataset;
provide time series models of topic evolution, such as derive predictors of interest via interrogation of dataset, estimate velocity trends of topics/segments using ensemble modeling, or verify model accuracy via holdout sample;
provide enhanced data analysis, e.g., with generative AI, such as principle component analysis to identify strategic themes, WHO audience profile, or identify key drivers of interest;
and/or generative AI tools can also be used to augment topics via the addition of key descriptors which add unique insight into the makeup of the topic; and/or generative AI tools score each topic with quantitative measures aimed at further profiling our topics, this added quantitative context to the collection of topics allows for additional analysis and sensemaking efforts in our approach.
populate a user dashboard, such as generating a unique “Baseball card” summary for each topic, create “Top trends” report, or enable user search function, e.g. by use of generative AI tools to create automated summaries for users which are of very high quality, the unique nature of Generative AI allowing for the creation of custom tailored analyses for our topics in an automated fashion which greatly enhances the value of our proposition;
craft one or more narratives for a client presentation, such as based on senior level consultant defined executive summary of findings, describe key trends for client to monitor, or prepare for in-person client presentation; and
provide ongoing dashboard refreshes augmented by Generative AI, such as provide client with ongoing live updates of trend development via software deliverable, the addition of Generative AI to customer dashboards allowing users to review engaging text-based summaries which greatly resemble human authorship as compared to simply viewing data and graphs without needed context and commentary.

2. A method for predicting consumer and market behavior for an industry, e.g., with a particular focus on uncovering deep insights at scale, the method comprising one or more of:
performing database curation, such as create custom queries, populate database from various content sources, or validate database structure, e.g., the method incorporating proprietary methods for processing data from unique data sources such as X (formerly known as Twitter) and Reddit and e.g., ensuring insights are maintained while facilitating analysis of the content;
ensuring data hygiene, such as remove irrelevant content, edit for non-text content, or deduplicate data and hold aside duplicate records;
establishing data hierarchy, such as leverage transformer based LLMs to add structure to database, utilize LLMs to create topic names, or enrich data with content generated by LLMs, including e.g., proprietary routines for the output of topic modeling results to ensure that the results are not skewed due to an inappropriate distribution of topics by size, e.g., overly large topics are decomposed into smaller topics while unduly small topics are merged with other like topics to ensure adequate sample size, the method enhancing the usability of the topic landscape created by the approach and ensuring that the results are balanced and representative of the broader dataset;
providing time series models of topic evolution, such as derive predictors of interest via interrogation of dataset, estimate velocity trends of topics/segments using ensemble modeling, or verify model accuracy via holdout sample;
providing enhanced data analysis, e.g., by generative AI, such as principle component analysis to identify strategic themes, WHO audience profile, or identify key drivers of interest;
populating a user dashboard, such as generate “Baseball card” summary for each topic, create “Top trends” report, or enable user search function, e.g., Generative AI tools are used to create automated summaries for users which are of very high quality, the unique nature of Generative AI allowing for the creation of custom tailored analyses for our topics in an automated fashion which greatly enhances the value of our proposition;
crafting one or more narratives for a client presentation, e.g., with generative AI, such as based on senior level consultant defined executive summary of findings, describe key trends for client to monitor, or prepare for in-person client presentation; and
providing ongoing dashboard refreshes, such as provide client with ongoing live updates of trend development via software deliverable, the additional of Generative AI to customer dashboards allowing users to review engaging text-based summaries which greatly resemble human authorship as compared to simply viewing data and graphs without needed context and commentary.
